(19) United States
(12) Patent Application Publication
(10) Pub. No.: US 2008/0074339 A1
(43) Pub. Date: Mar. 27, 2008

(54) BENT FOLDED DIPOLE ANTENNA FOR REDUCING BEAM WIDTH DIFFERENCE

(75) Inventors: Seung-Chul Lee, Pusan-shi (KR); Jae-Sun Jin, Incheon-shi (KR); Myung-Kuk Kim, Youngin-shi (KR)

Correspondence Address: DITTHAVONG MORI & STEINER, P.C., 918 Prince St., Alexandria, VA, 22314, US

(73) Assignee: Ace Antenna Corp., Incheon-shi (KR)

(21) Appl. No.: 11/622,847

(22) Filed: Jan. 12, 2007

(30) Foreign Application Priority Data
Sep. 26, 2006 (KR) 10-2006-0093198

(51) Int. Cl. H01Q 9/26

(52) U.S. Cl. 343/803; 343/795

(57) ABSTRACT

The present invention relates to a bent folded dipole antenna for reducing a beam width difference, which can reduce a beam width difference, varying with a frequency band, and generate dual polarization through the use of an antenna structure having a bent folded dipole antenna unit, in which a plurality of bent folded dipole components is connected to each other as a single pattern, and a feeding unit for feeding a signal to the folded dipole antenna unit.

Therefore, the present invention is advantageous in that it can reduce a beam width difference varying with a frequency band, simplify the structure of the antenna to reduce the cost thereof, and easily obtain dual polarization characteristics and wide band characteristics by combining a feeding unit for feeding a signal in a dual feeding manner with the bent folded dipole antenna unit implemented as a single pattern. In addition, the present invention is advantageous in that current flowing into the feed point of the feeding unit is induced only in folded dipole components without flowing into another feed point, thus realizing excellent isolation characteristics.

### BACKGROUND OF THE INVENTION

1. Field of the Invention

The present invention relates, in general, to a bent folded dipole antenna for reducing a beam width difference and, more particularly, to a bent folded dipole antenna, which reduces a beam width difference and has dual polarization characteristics and wide band characteristics, thanks to a structure in which a bent folded dipole antenna unit, which is formed of a plurality of bent folded dipole components each made of a metal plate or a copper plate and is implemented as a single pattern, is combined with a feeding unit for feeding a signal in a dual feeding manner.

2. Description of the Related Art

As conventional technology for a dual-polarized dipole antenna, a dual-polarized dipole antenna disclosed in Korean Patent Laid-Open Publication No. 2001-0040623 radiates polarization to a structurally prescribed alignment of dipoles at an angle of +45° or −45°. The end of the symmetrical, or substantially or approximately symmetrical, lines leading to respective dipole halves is connected in such a way that the corresponding line halves of the adjacent, mutually perpendicular dipole halves are always electrically connected. The electric feeding of the respectively diametrically opposite dipole halves is performed in a decoupled fashion for a first polarization and a second polarization orthogonal thereto.

However, since the conventional technology discloses a structure in which four dipoles, formed in a dipole square, are equally divided and separated, there is a problem in that the structure of the antenna is complicated, and the cost of the antenna increases due to the complicated structure.

There is another problem in that, since the conventional antenna is composed of four equally divided dipoles and two symmetrical pairs of feeding units, impedance matching is not easily performed, and wide band characteristics and antenna gain are deteriorated.

There is a further problem in that, in the case of a typical dipole antenna, such as the conventional antenna, as the frequency band is widened, a beam width difference increases, thus it is difficult to provide consistent speech quality for different frequencies.

### SUMMARY OF THE INVENTION

Accordingly, the present invention has been made keeping in mind the above problems occurring in the prior art, and an object of the present invention is to provide a bent folded dipole antenna, in which a plurality of bent folded dipole components, each made of a metal plate or a copper plate, forms a bent folded dipole antenna unit, so that the bent folded dipole antenna unit is implemented as a single pattern, thus simplifying the structure of the antenna and consequently reducing the manufacturing cost thereof.

Another object of the present invention is to provide a bent folded dipole antenna, which feeds a signal to a bent folded dipole antenna unit, implemented as a single pattern, using the structure of a feeding unit for feeding a signal in a dual feeding manner, thus further improving wide band characteristics and antenna gain characteristics while facilitating impedance matching.

A further object of the present invention is to provide a bent folded dipole antenna, which suitably adjusts the ratio of the lengths of the horizontal portion and the bent portion of each of a plurality of bent folded dipole components, and the angle of the bent portion with respect to the horizontal portion, so that a beam width difference is reduced in a wide frequency band, thus consistent speech quality for respective transmission/reception frequency bands can be provided.

In order to accomplish the above objects, the present invention provides a bent folded dipole antenna for reducing a beam width difference, comprising a bent folded dipole antenna unit, formed in such a way that a plurality of bent folded dipole components is connected to each other as a single pattern, and a feeding unit for feeding a signal to the bent folded dipole antenna unit.

Preferably, the bent folded dipole antenna unit may be implemented so that a direction of polarization is determined by a direction of currents of a fed signal which flows through the plurality of bent folded dipole components.

Preferably, the polarization may be formed through a vector composition of electric fields formed depending on a direction in which the currents flow.

Preferably, the bent folded dipole antenna unit may generate dual polarization using a dual feeding structure of the feeding unit for feeding a signal to the plurality of bent folded dipole components.

Preferably, each of the bent folded dipole components may be made of a metal plate or a copper plate.

Preferably, each of the bent folded dipole components may comprise a horizontal portion and a bent portion.

Preferably, the bent folded dipole antenna unit may be implemented so that a beam width thereof is adjusted by an angle of the bent portion.

Preferably, the bent folded dipole antenna unit may be implemented so that a beam width thereof is adjusted by lengths of the horizontal portion and the bent portion.

Preferably, the angle of the bent portion may be 45°±30°.

Preferably, the length of the horizontal portion may be 0.2 to 0.8 times as long as a length of the dipole component.

Preferably, the length of the bent portion may be 0.2 to 0.8 times as long as a length of the dipole component.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a bent folded dipole antenna for reducing a beam width difference according to an embodiment of the present invention;

FIG. 2 is a diagram showing the construction of the folded dipole antenna unit and the feeding unit of FIG. 1 according to the present invention;

FIG. 3 is a detailed diagram showing the folded dipole antenna unit of FIG. 1 according to the present invention;

FIG. 4A is a diagram showing polarization generated depending on a first current flow in FIG. 1;

FIG. 4B is a diagram showing polarization generated depending on a second current flow in FIG. 1;

FIG. 5 is a diagram showing the construction of the bent folded dipole component of FIG. 1 according to the present invention;

FIG. 6A is a graph showing variation in beam width relative to variation in angle at a frequency of 1.5 GHz according to an embodiment of the present invention;

FIG. 6B is a graph showing variation in beam width relative to variation in angle at a frequency of 2.0 GHz according to an embodiment of the present invention;

FIG. 6C is a graph showing variation in beam width relative to variation in angle at a frequency of 2.5 GHz according to an embodiment of the present invention; and

FIG. 7 is a graph showing variation in beam width relative to variation in the lengths of a horizontal portion and a bent portion at a frequency of 2.0 GHz according to an embodiment of the present invention.

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

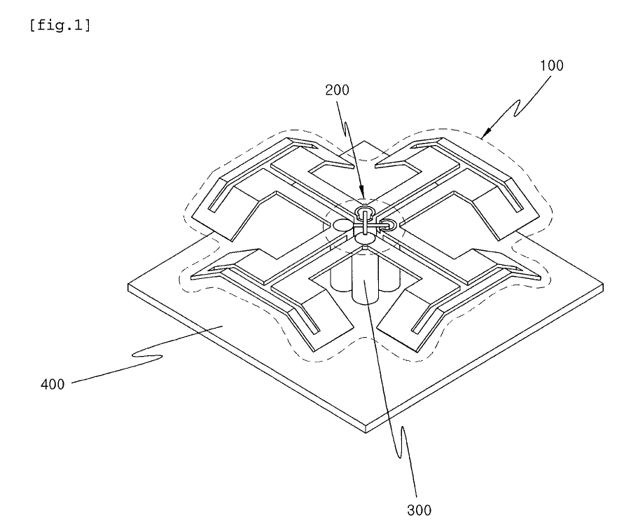

FIG. 1 is a perspective view showing a bent folded dipole antenna for reducing a beam width difference according to an embodiment of the present invention. The bent folded dipole antenna includes a bent folded dipole antenna unit 100 formed in such a way that first to fourth bent folded dipole components for reducing a beam width difference are connected to each other as a single pattern, a feeding unit 200 connected to the bent folded dipole antenna unit 100 and adapted to feed a signal, a balloon unit 300 adapted to support and fasten both the bent folded dipole antenna unit 100 and the feeding unit 200, and a ground unit 400 formed on the bottom of the balloon unit 300.

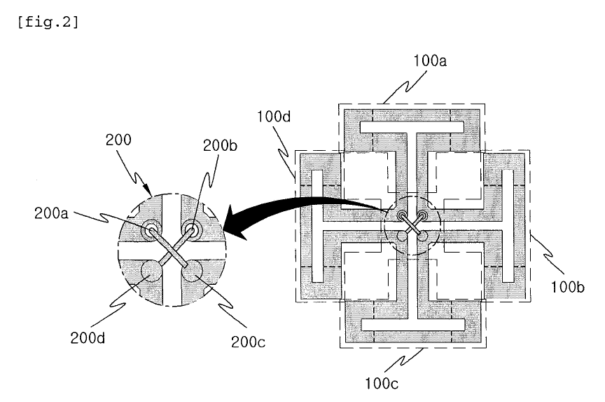

In detail, FIG. 2 is a diagram showing the construction of the bent folded dipole antenna unit and the feeding unit of FIG. 1 according to the present invention. In FIG. 2, first to fourth bent folded dipole components 100a to 100d are connected to each other as a single pattern to form the bent folded dipole antenna unit 100, reduce a beam width difference using the bending structure of the bent folded dipole antenna unit 100, and receive a signal fed from the feeding unit 200.

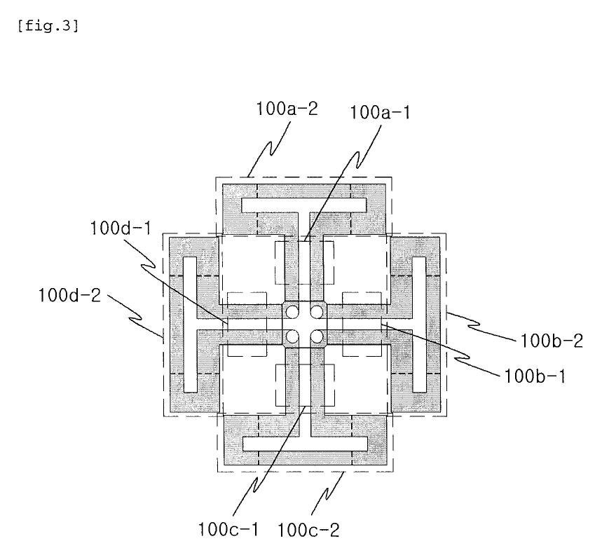

FIG. 3 is a detailed diagram showing the bent folded dipole antenna unit of FIG. 1. In the feeding unit 200, first to fourth feed points 200a to 200d are formed at locations at which the first to fourth feeder line parts 100a-1 to 100d-1 of the first to fourth bent folded dipole components 100a to 100d are to be mutually connected. Then, the first feed point 200a is connected to the third feed point 200c, and the second feed point 200b is connected to the fourth feed point 200d, so that the feeding unit 200 is formed such that the mutually connected first and third feed points 200a and 200c and the mutually connected second and fourth feed points 200b and 200d form an intersection. Accordingly, the feeding unit 200 feeds an externally applied signal to the first to fourth bent folded dipole components 100a to 100d in a dual feeding manner, thus generating dual polarization.

Further, current flowing into the feeding unit 200 is induced in the first to fourth bent folded dipole components 100a to 100d, thus excellent isolation characteristics can be obtained.

As shown in FIG. 3, the first bent folded dipole component 100a includes a first radiation part 100a-2 and a first feeder line part 100a-1. Current externally applied through the feeding unit 200 flows into the first feeder line part 100a-1, and the current flowing into the first feeder line part 100a-1 is induced in the first radiation part 100a-2.

Further, each of the second, third and fourth bent folded dipole components 100b, 100c and 100d includes a second, third or fourth feeder line part 100b-1, 100c-l or 100d-1, and the second, third or fourth radiation part 100b-2, 100c-2 or 100d-2. Current is induced in each of the second, third and fourth bent folded dipole components in response to a corresponding signal input from the feeding unit 200.

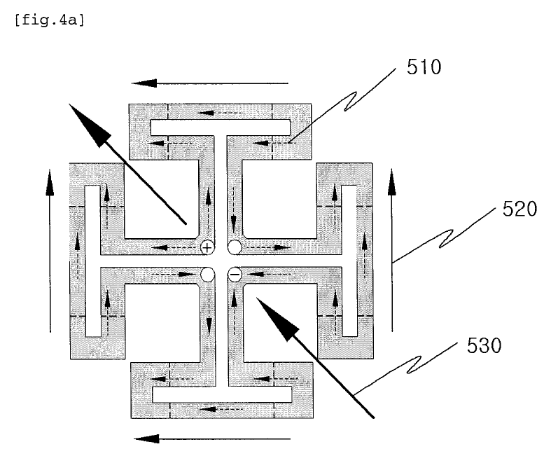

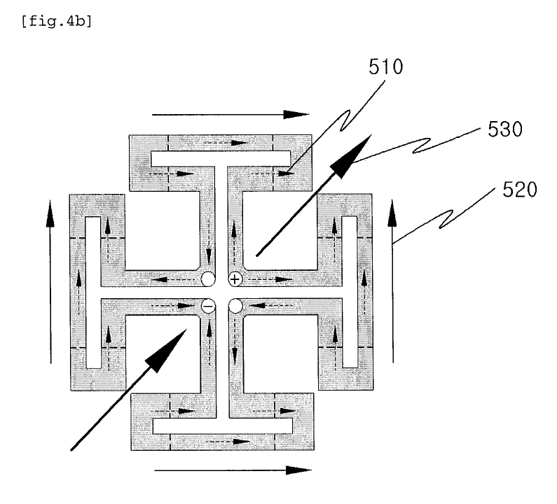

FIG. 4A is a diagram showing polarization generated depending on a first current flow in FIG. 1, and shows that electric fields are formed depending on the flow of currents, and one polarization of the two polarizations is generated through the vector composition of the electric fields. FIG. 4B is a diagram showing polarization generated depending on a second current flow in FIG. 1, and shows that electric fields are formed depending on the flow of currents, and the other polarization of the two polarizations is generated through the vector composition of the electric fields.

In detail, in FIG. 4A, a positive (+) current is applied to the first feed point 200a and a negative (−) current is applied to the third feed point 200c, so that currents having a direction 510 are formed in the first to fourth bent folded dipole components 100a to 100d depending on the applied currents, and electric fields having a direction 520 are formed at respective bent folded dipole components depending on the flow of the currents having the direction 510. Polarization having a direction 530 corresponding to an angle of +45° is formed through the vector composition of the electric fields, having the direction 520, formed at respective bent folded dipole components.

In FIG. 4B, a positive (+) current is applied to the second feed point 200b, and a negative (−) current is applied to the fourth feed point 200d, so that electric fields having a direction 520 are formed depending on the currents having a direction 510 which are formed in the first to fourth bent folded dipole components 100a to 100d. Polarization having a direction 530 corresponding to an angle of −45° is formed through the vector composition of the electric fields having the direction 520.

Therefore, FIGS. 4A and 4B show that the electric fields having directions 520 are formed depending on the currents having directions 510, respectively, and the polarizations having directions 530 corresponding to angles of +45° and −45° are generated, respectively, through the vector composition of the formed electric fields having the directions 520, thus obtaining dual polarization characteristics.

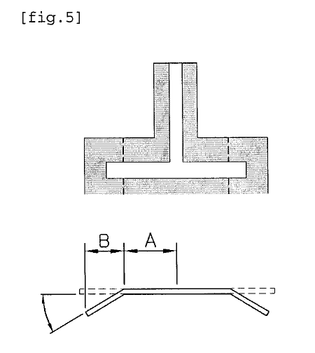

FIG. 5 is a diagram showing the bent folded dipole component of FIG. 1 according to the present invention. In FIG. 5, each of first to fourth bent folded dipole components 100a to 100d includes a horizontal portion A and a bent portion B. The angle of the bent portion B with respect to the horizontal portion A and the ratio of the length of the horizontal portion A to the length of the bent portion B are suitably adjusted, thus a beam width difference can be remarkably reduced.

Further, as the angle of the bent portion B increases, the beam width is widened. As the frequency band becomes higher, the extent to which the beam width is widened is increased.

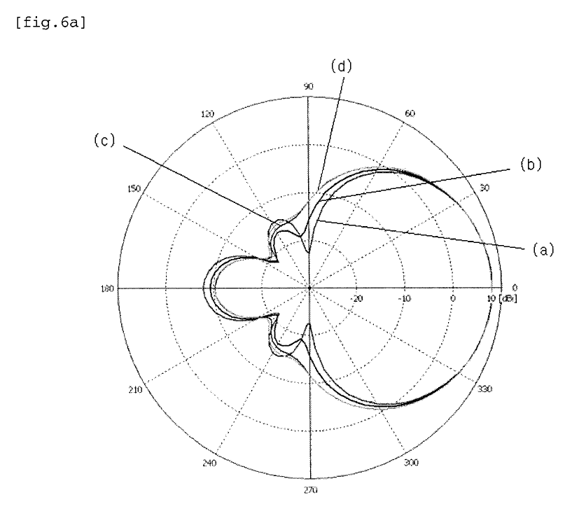

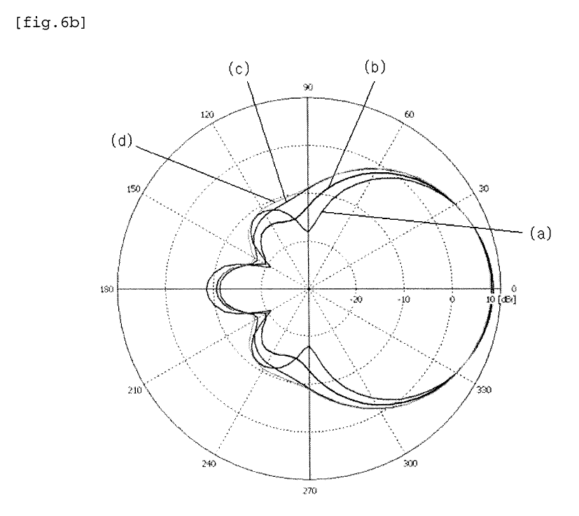

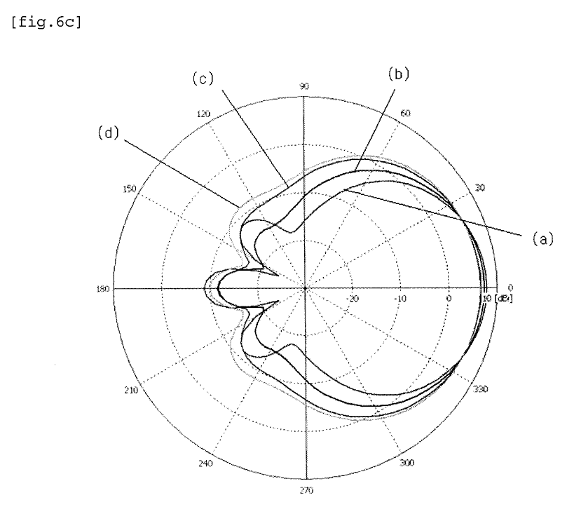

FIG. 6A is a graph showing variation in beam width relative to variation in angle at a frequency of 1.5 GHz according to an embodiment of the present invention, and illustrates variation in beam width relative to frequency and variation in the angle of the bent portion B when the ratio of the length of the horizontal portion A to the length of the bent portion B is fixedly set to 0.6:0.4.

In detail, FIG. 6A shows variation in beam width relative to variation in the angle of the bent portion B when the ratio of the length of the horizontal portion A to the length of the bent portion B is fixedly set to 0.6:0.4, and a frequency is set to 1.5 GHz. In FIG. 6A, (a), (b), (c) and (d) indicate beam widths when the angle of the bent portion B is 0°, 30°, 60°, and 900, respectively. It can be seen that, as the angle of the bent portion B increases from (a) to (d), the beam width is also widened.

FIG. 6B is a graph showing variation in beam width relative to variation in angle at a frequency of 2.0 GHz according to an embodiment of the present invention, and illustrates variation in beam width relative to variation in the angle of the bent portion B after the ratio of the length of the horizontal portion A to the length of the bent portion B is set to the same ratio as that of FIG. 6A, and the frequency is changed from 1.5 GHz to 2.0 GHz.

In detail, FIG. 6B shows variation in beam width relative to variation in the angle of the bent portion B when the frequency is 2.0 GHz. In FIG. 6B, (a), (b), (c) and (d) indicate beam widths when the angle of the bent portion B is 0°, 30°, 60°, and 90°, respectively. It can be seen that, as the angle of the bent portion B increases from (a) to (d), the beam width is also widened.

FIG. 6C is a graph showing variation in beam width relative to variation in angle at a frequency of 2.5 GHz according to an embodiment of the present invention, and illustrates variation in beam width relative to variation in the angle of the bent portion B after the ratio of the length of the horizontal portion A to the length of the bent portion B is set to the same ratio as that of FIGS. 6A and 6B, and a frequency is changed from 1.5 GHz or 2.0 GHz to 2.5 GHz.

In detail, FIG. 6C shows variation in beam width relative to variation in the angle of the bent portion B when the frequency is 2.5 GHz. In FIG. 6C, (a), (b), (c) and (d) indicate beam widths when the angle of the bent portion B is 0°, 30°, 60°, and 90°, respectively. It can be seen that, as the angle of the bent portion B increases from (a) to (d), the beam width is also widened.

Therefore, referring to FIGS. 6A, 6B and 6C, it can be seen that, as the frequency band becomes higher, the beam width is influenced more by variation in the angle of the bent portion B, and, as the angle of the bent portion B increases, the beam width is further widened.

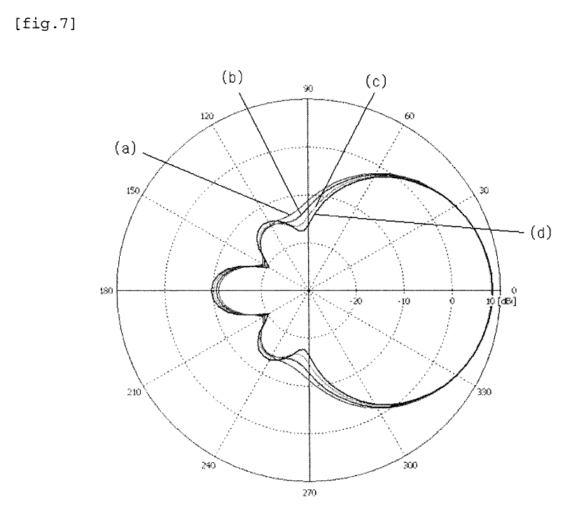

FIG. 7 is a graph showing variation in beam width relative to variation in the lengths of the horizontal portion and the bent portion at a frequency of 2.0 GHz according to an embodiment of the present invention, and illustrates variation in beam width relative to variation in the length of the horizontal portion A while the ratio of the length of the horizontal portion A to the length of the bent portion B is changed after the frequency has been fixedly set to 2.0 GHz, and the angle of the bent portion B has been fixedly set to 30°.

In detail, (a), (b), (c) and (d) indicate beam widths when the ratio of the length of the horizontal portion A to the length of the bent portion B is 0.2:0.8, 0.4:0.6, 0.6: 0.4, and 0.8:0.2, respectively. It can be seen that, as the length of the horizontal portion A increases, the beam width is also widened.

Therefore, it can be seen that, as the length of the horizontal portion A increases, the beam width is widened, and, as the frequency increases, variation in the beam width becomes large.

Further, it can be seen that variation in beam width according to the length of the horizontal portion A, as shown in FIG. 7, is less than variation in beam width according to the angle of the bent portion B, as shown in FIGS. 6A to 6C.

These results indicate that it is generally difficult for a wide band antenna to provide a constant beam width for each frequency compared to a narrow band antenna, but, if the bent folded dipole antenna provided by the present invention is used, the beam width difference for each frequency band can be reduced. Accordingly, if the bent folded dipole antenna of the present invention is applied, a wide band antenna exhibits beam width characteristics similar to those of a narrow band antenna, and a base station, which employs such an antenna, can provide consistent speech quality for respective transmission/reception frequencies, thus providing services having excellent quality.

As described above, the present invention provides a bent folded dipole antenna, in which a plurality of bent folded dipole components, each made of a metal plate or a copper plate, forms a bent folded dipole antenna unit, so that the bent folded dipole antenna unit is implemented as a single pattern. Accordingly, the present invention is advantageous in that it can reduce a beam width difference varying with a frequency band, simplify the structure of the antenna to reduce the cost thereof, and easily obtain dual polarization characteristics and wide band characteristics by combining a feeding unit for feeding a signal in a dual feeding manner with the bent folded dipole antenna unit implemented as a single pattern. In addition, the present invention is advantageous in that current flowing into the feed point of the feeding unit is induced only in folded dipole components without flowing into another feed point, thus realizing excellent isolation characteristics.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A bent folded dipole antenna for reducing a beam width difference, comprising:
a bent folded dipole antenna unit, formed in such a way that a plurality of bent folded dipole components is connected to each other as a single pattern; and
a feeding unit for feeding a signal to the bent folded dipole antenna unit.

2. The bent folded dipole antenna according to claim 1, wherein the bent folded dipole antenna unit is implemented so that a direction of polarization is determined by a direction of currents of a fed signal which flows through the plurality of bent folded dipole components.

3. The bent folded dipole antenna according to claim 2, wherein the polarization is formed through a vector composition of electric fields formed depending on a direction in which the currents flow.

4. The bent folded dipole antenna according to claim 1, wherein the bent folded dipole antenna unit generates dual polarization using a dual feeding structure of the feeding unit for feeding a signal to the plurality of bent folded dipole components.

5. The bent folded dipole antenna according to claim 4, wherein each of the bent folded dipole components is made of a metal plate or a copper plate.

6. The bent folded dipole antenna according to claim 5, wherein each of the bent folded dipole components comprises a horizontal portion and a bent portion.

7. The bent folded dipole antenna according to claim 6, wherein the bent folded dipole antenna unit is implemented so that a beam width thereof is adjusted by an angle of the bent portion.

8. The bent folded dipole antenna according to claim 6, wherein the bent folded dipole antenna unit is implemented so that a beam width thereof is adjusted by lengths of the horizontal portion and the bent portion.

9. The bent folded dipole antenna according to claim 7, wherein the angle of the bent portion is 45°±30°.

10. The bent folded dipole antenna according to claim 8, wherein the length of the horizontal portion is 0.2 to 0.8 times as long as a length of the dipole component.

11. The bent folded dipole antenna according to claim 8, wherein the length of the bent portion is 0.2 to 0.8 times as long as a length of the dipole component.
